(19) United States
(12) Patent Application Publication
(10) Pub. No.: US 2025/0087825 A1
(43) Pub. Date: Mar. 13, 2025

(54) BATTERY MODULE VENT GAS EVACUATION

(71) Applicant: GM Global Technology Operations LLC, Detroit, MI (US)

(72) Inventors: Anil Yadav, Troy, MI (US); Ryan Patrick Hickey, Austin, TX (US); Christopher Schlaupitz, White Lake, MI (US)

(21) Appl. No.: 18/465,287

(22) Filed: Sep. 12, 2023

(51) Int. Cl. H01M 50/358; H01M 10/658; H01M 50/209; H01M 50/211

(52) U.S. Cl. CPC H01M 50/358; H01M 10/658; H01M 50/209; H01M 50/211

(57) ABSTRACT

An apparatus for managing gases produced by batteries includes a battery case housing multiple battery cells, each with a vent for releasing pressurized gas. A thermal barrier layer is positioned beside the cells with sacrificial regions matching the vent count. On the other side of the barrier, a vent gas conduit collects gas from any venting cell through the sacrificial region, then directs it outside the battery case into the surrounding environment.

### INTRODUCTION

High-capacity lithium-ion battery packs are utilized in many consumer and industrial sectors categorically including transportation and power grid applications. High-capacity battery packs are known to include a plurality of battery pack modules allowing for flexibility in configurations and adaptation to application requirements. For example, in automotive uses, battery packs may be modular to the extent that the number of battery modules may be varied to accommodate a desired energy density or range objective of a particular vehicle platform, intended use, or other target. Battery modules may be constructed from tightly packaged pouch battery cells, prismatic battery cells or cylindrical battery cells, for example.

Undesirable thermal events in a lithium-ion battery cell due to local heating and/or bridging may cause damage to the cell. Battery cells may include designed cell vents for releasing internal cell pressurized gases during such thermal events. It is desirable to mitigate the spread of thermal events from one battery cell to another.

### SUMMARY

In one exemplary embodiment, an apparatus for evacuating battery vent gases may include a battery case containing a plurality of battery cells, at least one vent gas manifold adjacent the plurality of battery cells configured to receive a gas from any battery cell that is venting the gas from a respective cell vent and to isolate the gas from any battery cell that is not venting the gas, and at least one vent gas exhaust runner fluidly coupling the vent gas manifold to an ambient environment external to the battery case to provide a path for the gas isolated from the battery cells.

In addition to one or more of the features described herein, the apparatus may further include a thermal barrier layer between the at least one vent gas manifold and the battery cells, the thermal barrier layer including a plurality of sacrificial regions corresponding in number to the plurality of battery cells, each sacrificial region aligned over a corresponding cell vent.

In addition to one or more of the features described herein, the apparatus may further include a thermal barrier layer between the at least one vent gas exhaust runner and the battery cells.

In addition to one or more of the features described herein, the thermal barrier layer between the at least one vent gas manifold and the battery cells and the thermal barrier layer between the at least one vent gas exhaust runner and the battery cells are a unitary thermal barrier layer.

In addition to one or more of the features described herein, the thermal barrier layer between the at least one vent gas manifold and the battery cells may include mica.

In addition to one or more of the features described herein, the at least one vent gas exhaust runner has an effective length that is at least substantially one-half of a length of the at least one vent gas manifold.

In addition to one or more of the features described herein, the at least one vent gas exhaust runner may include a pair of vent gas exhaust runners and the at least one vent gas manifold is between the pair of vent gas exhaust runners.

In addition to one or more of the features described herein, the at least one vent gas exhaust runner substantially circumscribes the at least one vent gas manifold.

In addition to one or more of the features described herein, the at least one vent gas manifold may include multiple vent gas manifolds, and wherein the at least one vent gas exhaust runner is not between any two of the multiple vent gas manifolds.

In addition to one or more of the features described herein, the at least one vent gas manifold may include multiple vent gas manifolds, wherein the at least one vent gas exhaust runner comprises a single vent gas exhaust runner, and wherein the single vent gas exhaust runner is fluidly coupled to the multiple vent gas manifolds.

In addition to one or more of the features described herein, the at least one vent gas manifold may include a pair of vent gas manifolds and the at least one vent gas exhaust runner is between the pair of vent gas manifolds.

In addition to one or more of the features described herein, the at least one vent gas exhaust runner may include multiple vent gas exhaust runners having respective cross-sectional areas, wherein the at least one vent gas manifold comprises a single vent gas manifold having a respective cross-sectional area, and wherein the respective cross-sectional area of the single vent gas manifold is less than a sum of the respective cross sectional areas of the multiple vent gas exhaust runners.

In addition to one or more of the features described herein, the at least one vent gas exhaust runner and the at least one vent gas manifold are substantially coplanar.

In addition to one or more of the features described herein, the at least one vent gas exhaust runner and the at least one vent gas manifold are stacked in adjacent layers.

In addition to one or more of the features described herein, the at least one vent gas exhaust runner is open to the ambient environment external to the battery case at multiple ends of the battery case.

In another exemplary embodiment, an apparatus for evacuating battery vent gases may include a battery case containing a plurality of battery cells, and a vent gas conduit adjacent the plurality of battery cells configured to receive a gas from any battery cell that is venting the gas from a respective cell vent, isolate the gas from any battery cell that is not venting the gas and fluidly couple the gas through a runner to an ambient environment external to the battery case.

In addition to one or more of the features described herein, the apparatus may further include a thermal barrier layer between the vent gas conduit and the battery cells, the thermal barrier layer including a plurality of sacrificial regions corresponding in number to the plurality of battery cells, each sacrificial region aligned over a corresponding cell vent.

In yet another exemplary embodiment, an apparatus for evacuating battery vent gases may include a battery case containing a plurality of battery cells, each battery cell having a respective cell vent for releasing a pressurized gas from the respective battery cell, a thermal barrier layer having a first side adjacent to the battery cells and an opposite second side, the thermal barrier layer having a plurality of sacrificial regions corresponding in number to the plurality of battery cells, each sacrificial region aligned over a corresponding cell vent and responsive to the pressurized gas released from the corresponding cell vent to open and allow the pressurized gas to flow therethrough, and a vent gas conduit adjacent the second side of the thermal barrier layer and configured to receive the pressurized gas from any battery cell that is venting the pressurized gas from the respective cell vent through the corresponding sacrificial region, and fluidly couple the pressurized gas to an ambient environment external to the battery case.

In addition to one or more of the features described herein, the vent gas conduit includes a vent gas manifold receiving the pressurized gas and at least one vent gas exhaust runner, the at least one vent gas exhaust runner fluidly coupling the vent gas manifold to the ambient environment external to the battery case.

In addition to one or more of the features described herein, the at least one vent gas exhaust runner includes at least one switchback directional change.

### BRIEF DESCRIPTION OF THE DRAWINGS

Other features, advantages and details appear, by way of example only, in the following detailed description, the detailed description referring to the drawings in which:

FIGS. 1A and 1B illustrate a single vertical stack prismatic battery module, in accordance with one or more embodiments;

FIGS. 2A and 2B illustrate a single vertical stack pouch battery module, in accordance with one or more embodiments;

FIGS. 3A and 3B illustrate a dual horizontal stack pouch battery module, in accordance with one or more embodiments;

FIGS. 4A-4F depict vent gas conduits having a single vent gas manifold and a single vent gas runner, in accordance with one or more embodiments;

FIGS. 5A-5H depict vent gas conduits 111 having a single vent gas manifold 113 and a pair of vent gas runners 115, in accordance with one or more embodiments;

FIGS. 6A and 6B depict vent gas conduits 111 having a single vent gas manifold 113 and multiple vent gas runners 115, in accordance with one or more embodiments; and

FIGS. 7A-7C depict vent gas conduits 111 having dual vent gas manifolds 113 and either single or multiple vent gas runners 115, in accordance with one or more embodiments.

### DETAILED DESCRIPTION

The following description is merely exemplary in nature and is not intended to limit the present disclosure, its application or uses. Throughout the drawings, corresponding reference labels indicate like or corresponding parts and features. Description of parts and features in one drawing is understood to apply to parts and features in other drawings sharing the same reference labels to the extent such parts and features are not otherwise distinguishable through drawing examination by one having ordinary skill in the art or distinguished by additional written description herein.

In accordance with the present disclosure, apparatus for evacuating battery cell vent gases from battery modules are adapted for various battery cell types and configurations. For example, battery modules may be fabricated from one or more stacks of prismatic battery cells or pouch battery cells, or alternative groupings of cylindrical cells. Individual battery cells may be vertically oriented within a case or may be horizontally oriented within the case. Multiple stacks of battery cells may be packaged together in a battery module, for example two horizontally oriented stacks may be packaged side by side in a single battery module or two vertically oriented stacks may be packaged together one on top of the other in a single battery module. Hot gases venting from a battery cell within a battery module may be collected within a vent gas conduit, isolated from the remaining battery cells that are not venting, and directed to the ambient environment external to the battery case. The ambient environment may be within a battery pack enclosure where the battery module is one of a plurality of such battery modules within such an enclosure. The vent gas conduit may include a vent gas manifold that is arranged in proximity to the cell vents such that hot gases vented from any cell may be collected within the manifold. The manifold may be fluidly coupled to a vent gas exhaust runner that opens to the ambient environment external to the battery case. The vent gas conduit may include one or more vent gas manifolds and one or more vent gas exhaust runners. The vent gas exhaust runner may increase the distance that the gas travels before being released to the ambient environment outside of the battery case versus an unconstrained and undirected exhaust path. Thus, the path provided by the vent gas runner may be considered circuitous in so far as it may be longer than the most direct path for the gas to exit the battery case, which may result in a cooler gas when it is released to the ambient environment. In some embodiments the vent gas runner may be a straight run from the manifold to the runner exit. In other embodiments, the gas vent runner may be tortuous and include turns and redirections, including switchback directional changes in order to increase the length of travel of the vent gas. In some embodiments, the vent gas manifold may open to a vent gas runner having a larger physical or effective cross-sectional area than the vent gas manifold thus allowing for volumetric expansion of the gas, which may result in a cooler gas when it is released to the ambient environment. In some embodiments the vent gas runner may split the gas flow and be directed to multiple exits points. In some embodiments, the split gas flow may be recombined downstream in the gas vent runner. In some embodiments, the vent gas conduit may be on one side of a single stack of battery cells and interface with a single stack of battery cells, whereas in other embodiments the vent gas conduit may interface with two adjacent stacks of battery cells that are side by side or vertically stacked. In some embodiments, a thermal barrier layer may be between the gas vents of the battery cell stack and the gas vent manifold and include sacrificial regions over the cell vents designed to burst or yield to the pressurized gas being vented from corresponding cell vents such that the remaining, non-venting battery cells are thermally isolated from the vented gas in the vent gas manifold. Similarly, the thermal barrier layer may be extended between the vent gas runner and the battery cells so they are thermally isolated from the vented gas in the vent gas runner. In some embodiments, the gas vent manifold and the gas vent runner may be substantially coplanar on a single layer. In other embodiments, the vent gas manifold and the vent gas runner may be stacked in adjacent layers.

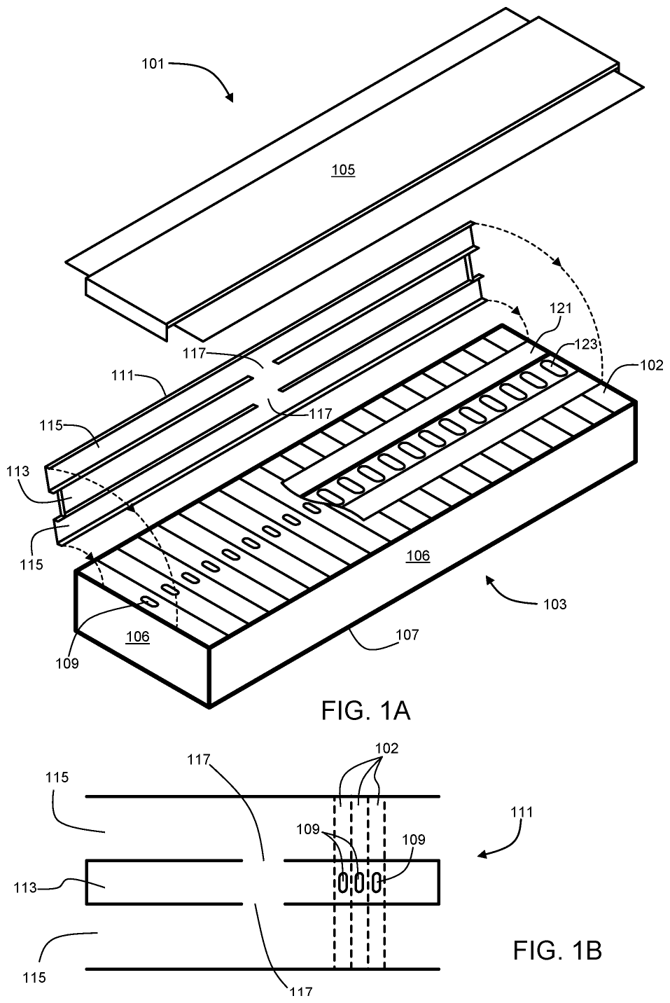

FIGS. 1A and 1B illustrate an exemplary embodiment of a battery module 101, which may be one of a number of similar battery modules included in, for example, a battery electric vehicle battery pack. Such an exemplary battery module may find application outside of battery electric vehicles, for example in off grid power quality and storage applications, in other pack combinations or as a stand-alone battery module.

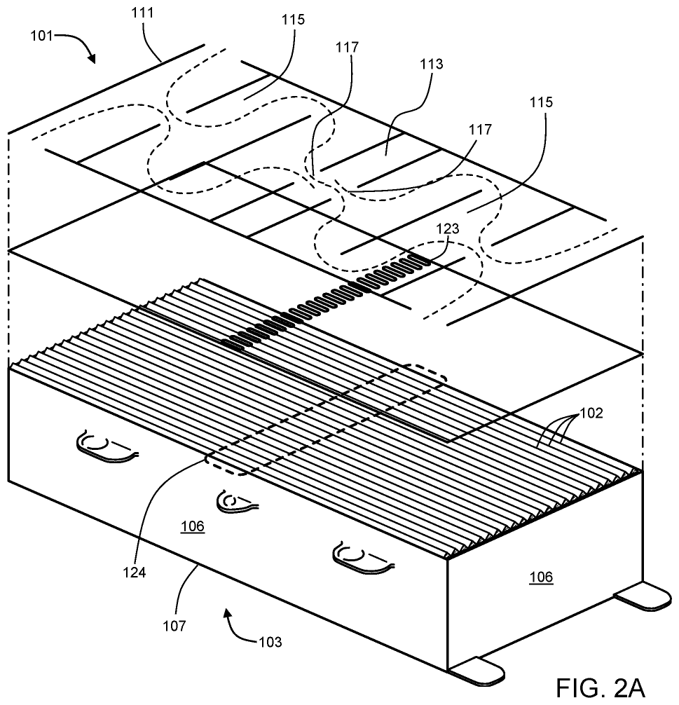

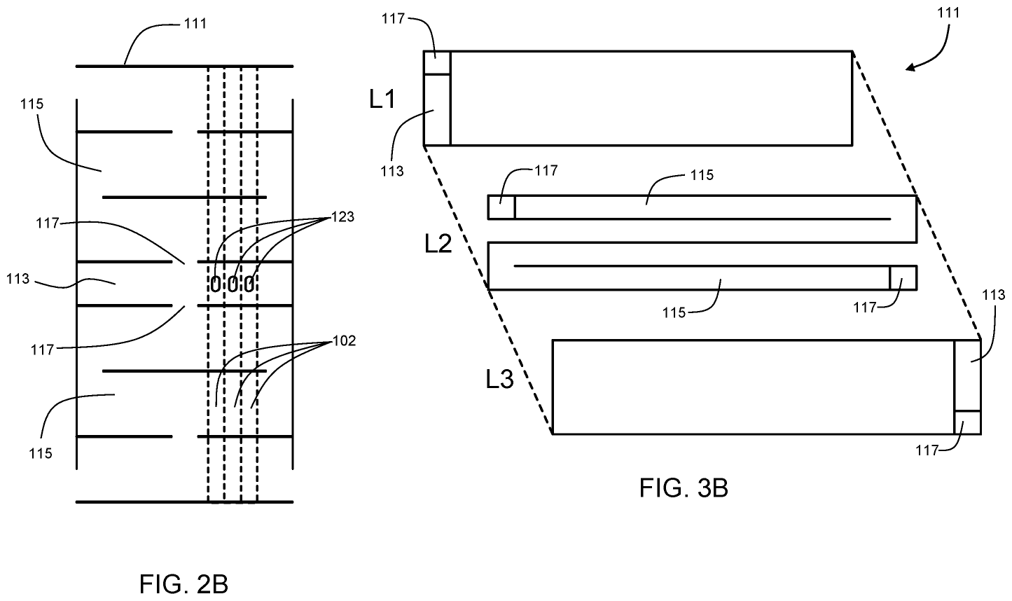

Battery module 101 may include a cover 105 and opposing bottom 107, and side walls 106 which generally define a substantially rectangular case 103 as illustrated. The case 103 may provide structure, mounting features, electrical connections, and containment of a plurality of battery cells 102. The embodiment of FIGS. 1A and 2A illustrates a single stack of vertically oriented, prismatic battery cells 102 within the case 103. Each battery cell 102 may include a respective cell vent 109. The cell vents 109 may be strategically designed to rupture at a certain pressure threshold, allowing the gas to escape and thereby relieving pressure within the cell. FIGS. 1A and 1B illustrate an embodiment wherein the cell vents 109 are centrally located between opposite ends of the battery cell 102. The illustrated central location of the cell vents 109 is exemplary, it being understood that the location may be closer to one end than the other. A vent gas conduit 111 is illustrated to show the features which form a central vent gas manifold 113 and multiple vent gas runners 115 on either side thereof. The vent gas runners 115 are fluidly coupled to the vent gas manifold 113 through ports 117. The vent gas runners 115 are also open at the end of their runs which may coincide with the ends or limits of the case 103 such that gas vented into the vent gas manifold 113 moves through the ports 117, into and through the vent gas runners 115, and exits the case 103 to the ambient environment external to the battery case 103. In an embodiment, a thermal barrier layer 121 may be on the stack of vertically oriented, prismatic battery cells 102 over the cell vents 109. The thermal barrier layer 121 may include a plurality of sacrificial regions 123 aligned over the plurality of cell vents 109. It is appreciated that such a thermal barrier 121 is between the battery cells 102 and at least the vent gas manifold 113. It is appreciated that such a thermal barrier 121 may also be between the battery cells 102 and the vent gas runners 115. In an embodiment, the thermal barrier layer 121 and the sacrificial regions 123 may be fabricated from the same material. In an embodiment, the thermal barrier layer 121 may be fabricated from a mica sheet and the sacrificial regions may be thinned out regions of mica. The mica sheet may be self-structural or it may be carried on or embedded as a composite layer within a substrate. Mica tape or thin, flexible aluminum foil backed glass cloth composites (heat spreading tape) may be adhesively applied to a carrier to provide the thermal barrier layer. Alternative materials for the thermal barrier layer 121 may include refractory materials, silicone elastomers, high glass filled nylon, graphite, ceramics such as alumina, zirconia, and non-porous cordierite.

FIGS. 2A and 2B illustrate an exemplary embodiment of a battery module 101, which may be one of a number of similar battery modules included in, for example, a battery electric vehicle battery pack. Such an exemplary battery module may find application outside of battery electric vehicles, for example in on and off grid power quality and storage applications, in other pack combinations or as a stand-alone battery module.

Battery module 101 may include a cover (not illustrated) similar to the embodiment of FIG. 1A and opposing bottom 107, and side walls 106 which generally define a substantially rectangular case 103 as illustrated. The case 103 may provide structure, mounting features, electrical connections, and containment of a plurality of battery cells 102. The embodiment of FIGS. 2A and 2B illustrates a single stack of vertically oriented, pouch battery cells 102 within the case 103. Each battery cell 102 may include a respective cell vent located within region 124. The cell vents may be strategically designed to rupture at a certain pressure threshold, allowing the gas to escape and thereby relieving pressure within the cell. FIG. 2A illustrates an embodiment wherein the cell vents region 124 is centrally located between opposite ends of the battery cells 102. The illustrated central location of the cell vents is exemplary, it being understood that the location may be closer to one end than the other. A vent gas conduit 111 is illustrated schematically to show the features which form a central vent gas manifold 113 and a pair of vent gas runners 115 on either side thereof. The vent gas runners 115 are fluidly coupled to the vent gas manifold 113 through ports 117. The vent gas runners 115 are also open at the end of their runs which may coincide with the ends or limits of the case 103 such that gas vented into the vent gas manifold 113 moves through the ports 117, into and through the vent gas runners 115, and exits the case 103 to the ambient environment external to the battery case 103. In an embodiment, a thermal barrier layer 121 may be on the stack of vertically oriented, pouch battery cells 102 over the cell vents in the cell vents region 124. The thermal barrier layer 121 may include a plurality of sacrificial regions 123 aligned over the plurality of cell vents in the cell vents region 124. It is appreciated that such a thermal barrier 121 is between the battery cells 102 and at least the vent gas manifold 113. It is appreciated that such a thermal barrier 121 may also be between the battery cells 102 and the vent gas runners 115. In an embodiment, the thermal barrier layer 121 and the sacrificial regions 123 may be fabricated from the same material. In an embodiment, the thermal barrier layer 121 may be fabricated from a mica sheet and the sacrificial regions may be thinned out regions of mica. The mica sheet may be self-structural or it may be carried on or embedded as a composite layer within a substrate. Mica tape or thin, flexible aluminum foil backed glass cloth composites (heat spreading tape) may be adhesively applied to a carrier to provide the thermal barrier layer. Alternative materials for the thermal barrier layer 121 may include refractory materials, silicone elastomers, high glass filled nylon, graphite, ceramics such as alumina, zirconia, and non-porous cordierite.

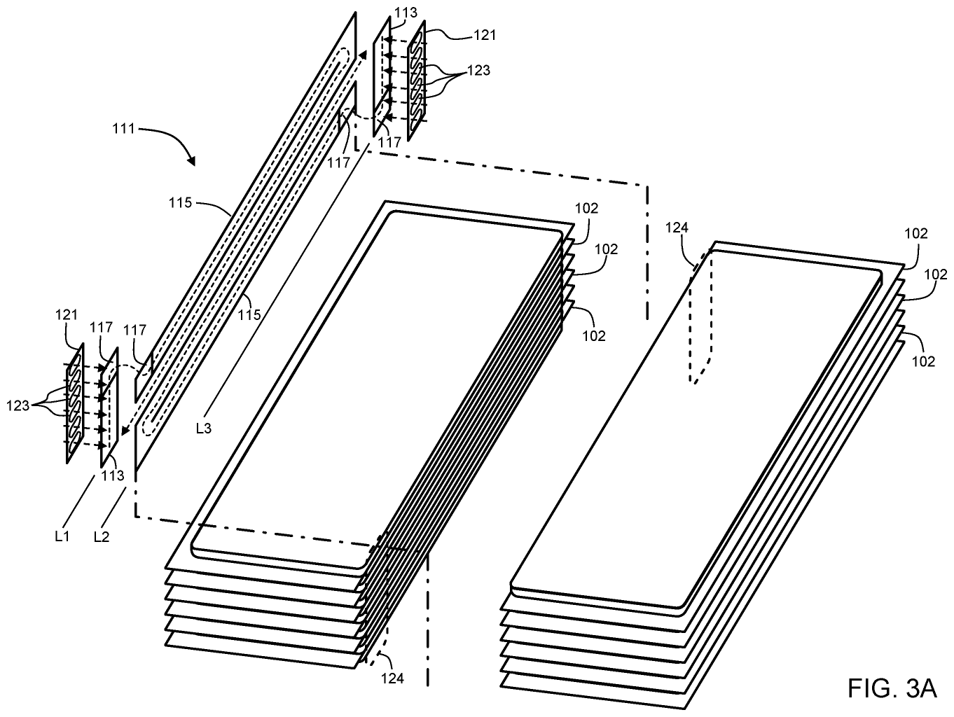

FIGS. 3A and 3B illustrate an exemplary embodiment of a battery module 101, which may be one of a number of similar battery modules included in, for example, a battery electric vehicle battery pack. Such an exemplary battery module may find application outside of battery electric vehicles, for example in on and off grid power quality and storage applications, in other pack combinations or as a stand-alone battery module.

Battery module 101 may include a cover, opposing bottom, and side walls which generally define a substantially rectangular case (not illustrated) similar to the embodiments of FIGS. 1A and 2A. The case may provide structure, mounting features, electrical connections, and containment of a plurality of battery cells 102. The embodiment of FIGS. 3A and 3B illustrates a pair of stacks of horizontally oriented, pouch battery cells 102 within the case. Each battery cell 102 may include a respective cell vent located within region 124. The cell vents may be strategically designed to rupture at a certain pressure threshold, allowing the gas to escape and thereby relieving pressure within the cell. FIG. 3A illustrates an embodiment wherein the cell vents region 124 is located toward one end of the battery cells 102. The illustrated end location of the cell vents is exemplary, it being understood that the location may be closer to the center of the battery cells 102. A vent gas conduit 111 is illustrated between the stacks of battery cells. The vent gas conduit 111 is illustrated schematically to show the features which form a vent gas manifold 113 for the respective stacks and a pair of vent gas runners 115 between the vent gas manifolds 113. Each vent gas runner 115 is fluidly coupled to a respective vent gas manifold 113 through ports 117. The vent gas runners 115 are also open at the end of their runs which may coincide with the ends or limits of the case such that gas vented into the vent gas manifold 113 moves through the ports 117, into and through the vent gas runners 115, and exits the case to the ambient environment external to the battery case. In the embodiment of FIGS. 3A and 3B, the vent gas runners 115 are between the vent gas manifolds 113 (i.e., stacked in adjacent layers) with the vent gas runners on a layer L2 and the vent gas manifolds 113 on respective outer layers L1 and L3. In an embodiment, a thermal barrier layer 121 may be on the stack of vertically oriented, pouch battery cells 102 over the cell vents in the cell vents region 124. The thermal barrier layer 121 may include a plurality of sacrificial regions 123 aligned over the respective plurality of cell vents in the cell vents regions 124. It is appreciated that such a thermal barrier 121 is between the battery cells 102 and at least the vent gas manifold 113. It is appreciated that such a thermal barrier 121 may also be between the battery cells 102 and the vent gas runners 115. In an embodiment, the thermal barrier layer 121 and the sacrificial regions 123 may be fabricated from the same material. In an embodiment, the thermal barrier layer 121 may be fabricated from a mica sheet and the sacrificial regions may be thinned out regions of mica. The mica sheet may be self-structural or it may be carried on or embedded as a composite layer within a substrate. Mica tape or thin, flexible aluminum foil backed glass cloth composites (heat spreading tape) may be adhesively applied to a carrier to provide the thermal barrier layer. Alternative materials for the thermal barrier layer 121 may include refractory materials, silicone elastomers, high glass filled nylon, graphite, ceramics such as alumina, zirconia, and non-porous cordierite.

The remaining FIGS. schematically illustrate various exemplary embodiments of vent gas conduits 111 in relation to several exemplary battery cells 102 in a stack for context. These exemplary embodiments are not intended to be limiting.

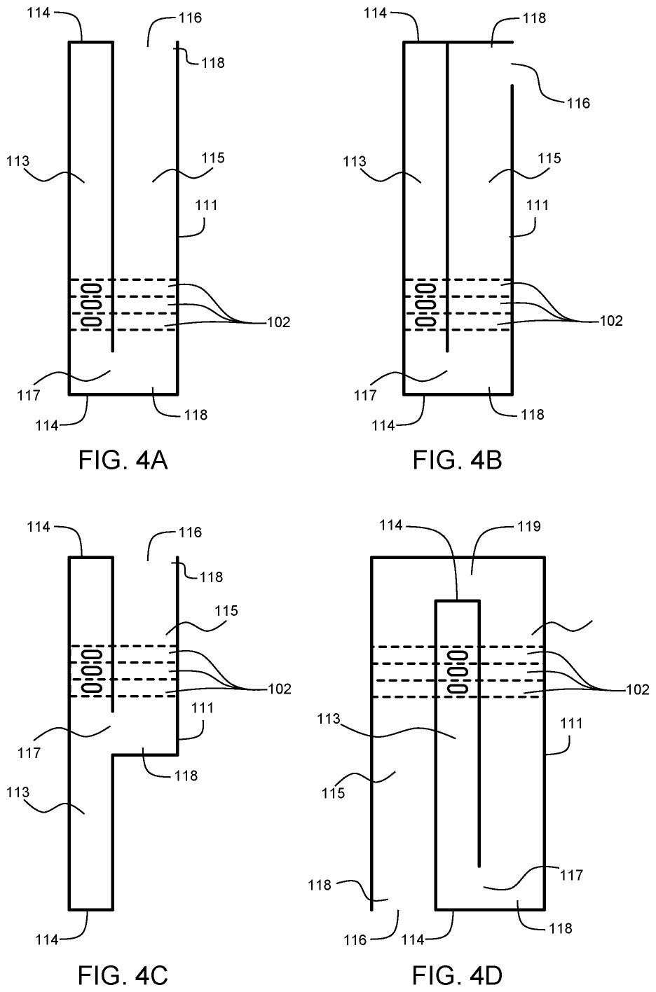

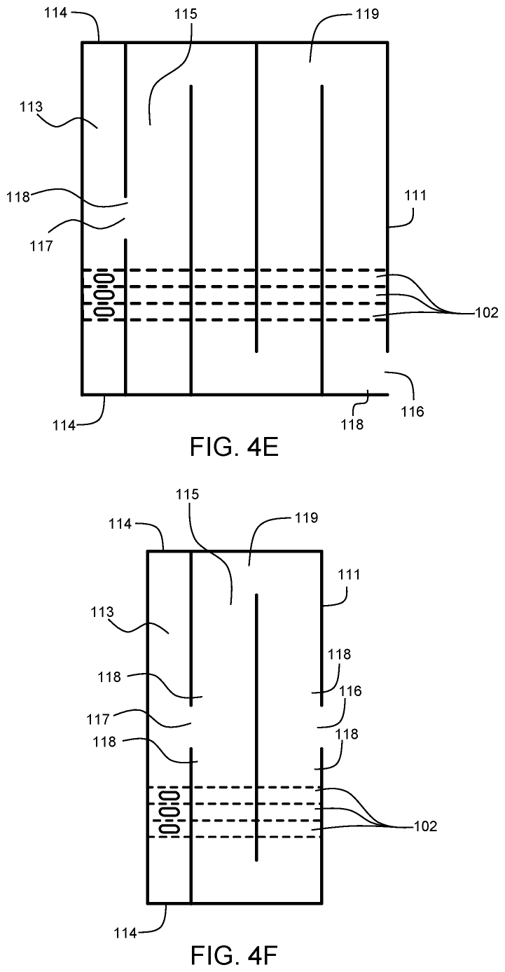

FIGS. 4A-4F depict embodiments of vent gas conduits 111 having a single vent gas manifold 113 and a single vent gas runner 115 which, for purposes of the present description, means a path for battery cell vent gas from a port 117 to an outlet 116 at the end of the run of the vent gas runner 115.

FIG. 4A depicts a single, elongated vent gas manifold 113, a single port 117 located at one of its two ends 114 and opening to a single, elongated vent gas runner 115 at one of its two ends 118. The vent gas runner 115 opens at the other one of its two ends 118 to an outlet 116 to the ambient environment external to the corresponding battery case (not shown). It is thus appreciated that the vent gas runner is about as long as the vent gas manifold 113. FIG. 4B depicts an embodiment equivalent to the embodiment depicted in FIG. 4A with the notable exception that its outlet 116, while also at the end 118 opposite the port 117, opens through a side wall of the vent gas runner 115. It may be appreciated that the outlet 116 positioning may merely be a design implementation to effect a particular desired release direction for the battery cell vent gas. FIG. 4C depicts a single, elongated vent gas manifold 113, a single port 117 located midway between its two ends 114 and opening to a single, elongated vent gas runner 115 at one of its two ends 118. The vent gas runner 115 opens at the other one of its two ends 118 to an outlet 116 to the ambient environment external to the corresponding battery case (not shown). It is thus appreciated that the vent gas runner 115 is about half as long as the vent gas manifold 113. FIG. 4D, similar to the embodiments depicted in FIGS. 4A and 4B, depicts a single, elongated vent gas manifold 113 and a single port 117 located at one of its two ends 114 and opening to a single, elongated vent gas runner 115 at one of its two ends 118. However, the vent gas runner 115 in the embodiment of FIG. 4D includes a switchback directional change 119 wrapping the vent gas manifold end 114 opposite the port 117 to continue its run to the other one of its two ends 118 to an outlet 116 to the ambient environment external to the corresponding battery case (not shown). It is thus appreciated that the vent gas runner 115 is laid out on both sides of the vent gas manifold 113 and is about twice as long as the vent gas manifold 113. It is noted that the outlet 116 may alternatively open through a side wall of the vent gas runner 115 as described with respect to the embodiment of FIG. 4B. FIG. 4E, similar to the embodiment depicted in FIG. 4C, depicts a single, elongated vent gas manifold 113 and a single port 117 located midway between its two ends 114 and opening to a single, elongated vent gas runner 115. The vent gas runner 115 in the embodiment of FIG. 4E includes several switchback directional changes 119 between its two ends 118 thus providing a meandering, serpentine vent gas runner 115 to an outlet 116 to the ambient environment external to the corresponding battery case (not shown). It is thus appreciated that the vent gas runner 115 is over three times as long as the length of the vent gas manifold 113. FIG. 4F also depicts a single, elongated vent gas manifold 113 and a single port 117 located midway between its two ends 114 and opening to a single, elongated vent gas runner 115. The vent gas runner 115 in the embodiment of FIG. 4F provides for a split gas flow (up and down in the depiction) as battery cell vent gas exits the vent gas manifold 113 at the port 117 and includes a switchback directional change 119 for each flow path between its two ends 118 thus providing for additional volumetric expansion of the gas without such a split flow. It is also appreciated that the vent gas runner 115, using each split path from the port 117 to the outlet 116 as a metric, is about as long as the length of the vent gas manifold 113.

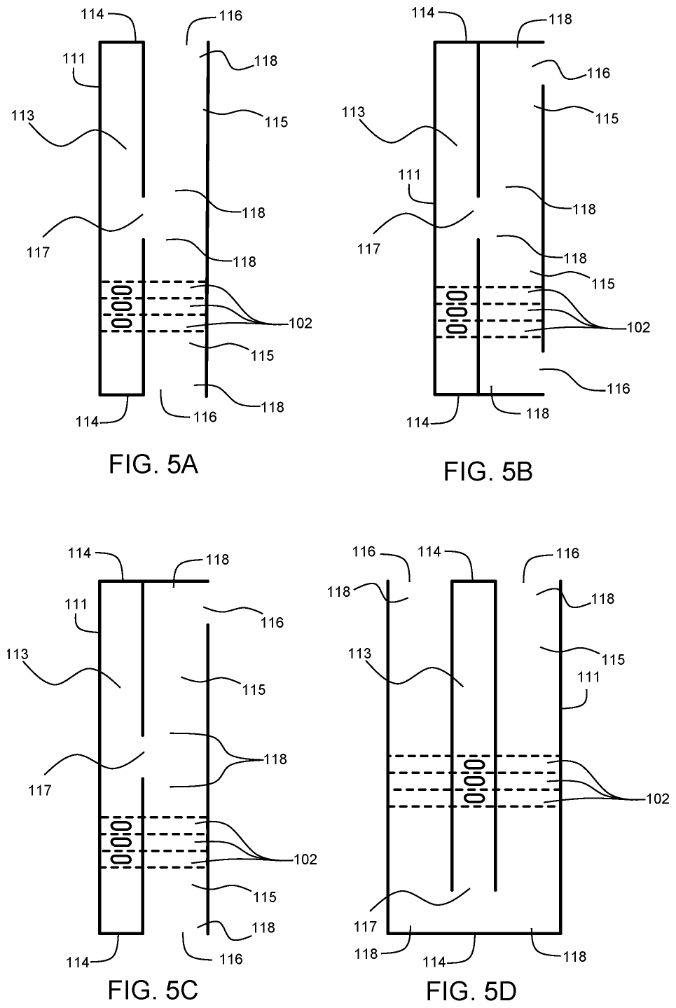

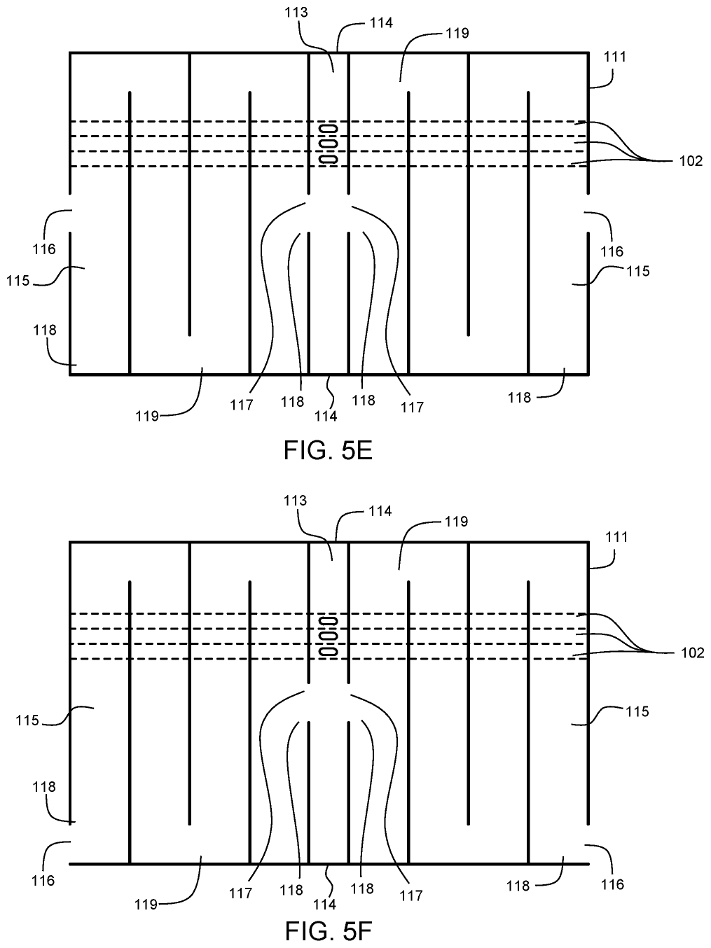

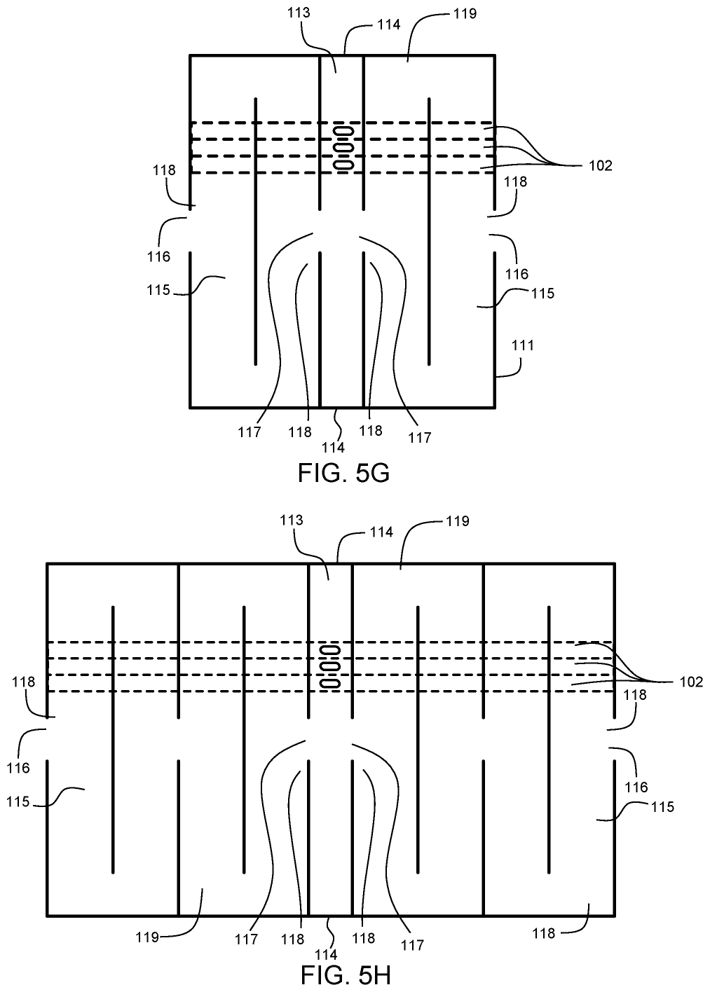

FIGS. 5A-5H depict embodiments of vent gas conduits 111 having a single vent gas manifold 113 and a pair of vent gas runners 115 which, for purposes of the present description, means a path for battery cell vent gas from a port 117 to a respective outlet 116 at the end of the respective run of the vent gas runner 115.

FIG. 5A depicts a single, elongated vent gas manifold 113 and a single port 117 located midway between its two ends 114 and opening to a pair of elongated vent gas runners 115. The vent gas runners 115 in the embodiment of FIG. 5A provide for a split gas flow (up and down in the depiction) as battery cell vent gas exits the vent gas manifold 113 at the port 117 thus providing for additional volumetric expansion of the gas without such a split flow. Each vent gas runner 115 opens at one of its two ends 118 to the port 117 and at the other one of its two ends 118 to a respective outlet 116 to the ambient environment external to the corresponding battery case (not shown). It is also appreciated that each vent gas runner 115, using each split path from the port 117 to the outlet 116 as a metric, is about half as long as the length of the vent gas manifold 113. FIG. 5B depicts an embodiment equivalent to the embodiment depicted in FIG. 5A with the notable exception that the outlets 116, while also at the ends 118 opposite the port 117, open through a side wall of the vent gas runners 115. It may be appreciated that the outlets 116 positioning may merely be a design implementation to effect a particular desired release direction for the battery cell vent gas. FIG. 5C depicts an embodiment equivalent to the embodiments depicted in FIGS. 5A and 5B with the notable exception that one of the outlets 116, while also at the respective end 118 opposite the port 117, opens through a side wall of the respective vent gas runner 115, whereas the other of the outlets 116, while also at the respective end 118 opposite the port 117, opens through the end of the respective vent gas runner 115. It may be appreciated that the outlet 116 positioning may merely be a design implementation to effect a particular desired release direction for the battery cell vent gas and that the desired release directions may differ for each respective vent gas runner 115 in embodiments with multiple vent gas runners 115. FIG. 5D also depicts a single, elongated vent gas manifold 113 and a single port 117 opening to a pair of elongated vent gas runners 115. However, the port 117 is located at one of the two ends 114 of the vent gas manifold 113. The vent gas runners 115 in the embodiment of FIG. 5D provide for a split gas flow as battery cell vent gas exits the vent gas manifold 113 at the port 117 thus providing for additional volumetric expansion of the gas without such a split flow. It is thus appreciated that the vent gas runners 115 are laid out on both sides of the vent gas manifold 113. It is also appreciated that each vent gas runner 115 from the port 117 to the respective outlet 116 at the end 118 of each vent gas runner 115 opposite the port 117 is about as long as the length of the vent gas manifold 113. FIG. 5E depicts a single, elongated vent gas manifold 113 with dual ports 117 located midway between its two ends 114 and opening on opposite sides of the vent gas manifold 113 to respective elongated vent gas runners 115. The vent gas runners 115 in the embodiment of FIG. 5E provide for a split gas flow as battery cell vent gas exits the vent gas manifold 113 through the dual ports 117 thus providing for additional volumetric expansion of the gas without such a split flow. Each vent gas runner 115 in the embodiment of FIG. 5E includes several switchback directional changes 119 between its two ends 118 thus providing a meandering, serpentine vent gas runner 115 to an outlet 116 to the ambient environment external to the corresponding battery case (not shown). It is thus appreciated that each vent gas runner 115 is about three times as long as the length of the vent gas manifold 113 as depicted with the outlet located midway in the vent gas runner 115 outermost wall. It is further appreciated that either or both of the vent gas runners may be made longer by about another one half of the length of the vent gas manifold 113 by relocating the outlet 116 to the end of the vent gas runner 115 as depicted in the embodiment of FIG. 5F. FIG. 5G also depicts a single, elongated vent gas manifold 113 with dual ports 117 located midway between its two ends 114 and opening on opposite sides of the vent gas manifold 113 to respective elongated vent gas runners 115. Each vent gas runner 115 in the embodiment of FIG. 5G provides for a split gas flow (up and down in the depiction) as battery cell vent gas exits the vent gas manifold 113 at the respective port 117 and includes a switchback directional change 119 for each flow path between its two ends 118 thus providing for additional volumetric expansion of the gas without such a split flow. It is also appreciated that each vent gas runner 115, using each split path from the respective port 117 to the respective outlet 116 as a metric, is about as long as the length of the vent gas manifold 113. FIG. 5H depicts an embodiment similar to the embodiment of FIG. 5G but with extended length vent gas runners 115 wherein split gas flows recombine and split again within each vent gas runner 115.

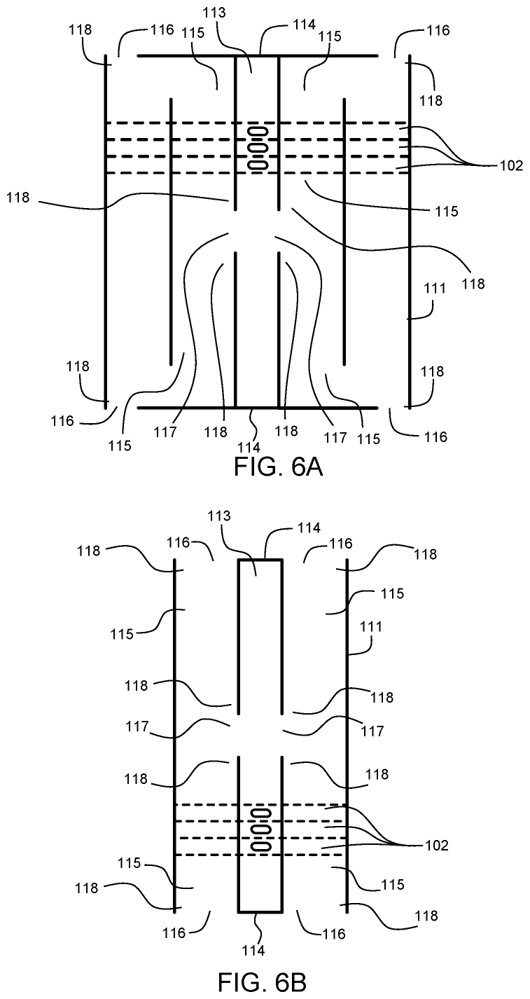

FIGS. 6A and 6B depict embodiments of vent gas conduits 111 having a single vent gas manifold 113 and multiple vent gas runners 115 which, for purposes of the present description, means a path for battery cell vent gas from a port 117 to a respective outlet 116 at the end of the respective run of a vent gas runner 115.

FIG. 6A depicts a single, elongated vent gas manifold 113 with dual ports 117 located midway between its two ends 114 and opening on opposite sides of the vent gas manifold 113 to respective pairs of elongated vent gas runners 115. Each vent gas runner 115 in the embodiment of FIG. 6A provides for a split gas flow (up and down in the depiction) as battery cell vent gas exits the vent gas manifold 113 at the respective port 117 and includes a switchback directional change 119 for each flow path between its two ends 118 thus providing for additional volumetric expansion of the gas without such a split flow. It is appreciated that each vent gas runner 115, using each split path from the respective port 117 to the respective outlet 116 as a metric, is about half as long as the length of the vent gas manifold 113. It is also appreciated that the multiplicity of vent gas runners 115 and corresponding multiplicity of respective outlets 116 effectively distributes the battery cell vent gas and heat content so as to avoid concentration of the gas and heat to a more limited region as would be the case with fewer vent gas runners 115 and outlets 116. FIG. 6B depicts a single, elongated vent gas manifold 113 with dual ports 117 located midway between its two ends 114 and opening on opposite sides of the vent gas manifold 113 to respective pairs of elongated vent gas runners 115. The vent gas runners 115 in the embodiment of FIG. 6B provide for a split gas flow (up and down in the depiction) as battery cell vent gas exits the vent gas manifold 113 at the respective port 117 thus providing for additional volumetric expansion of the gas without such a split flow. Each vent gas runner 115 opens at one of its two ends 118 to the respective port 117 and at the other one of its two ends 118 to a respective outlet 116 to the ambient environment external to the corresponding battery case (not shown). It is also appreciated that each vent gas runner 115, using each split path from the port 117 to the outlet 116 as a metric, is about half as long as the length of the vent gas manifold 113. It is also appreciated that the multiplicity of vent gas runners 115 and corresponding multiplicity of respective outlets 116 effectively distributes the battery cell vent gas and heat content so as to avoid concentration of the gas and heat to a more limited region as would be the case with fewer vent gas runners 115 and outlets 116.

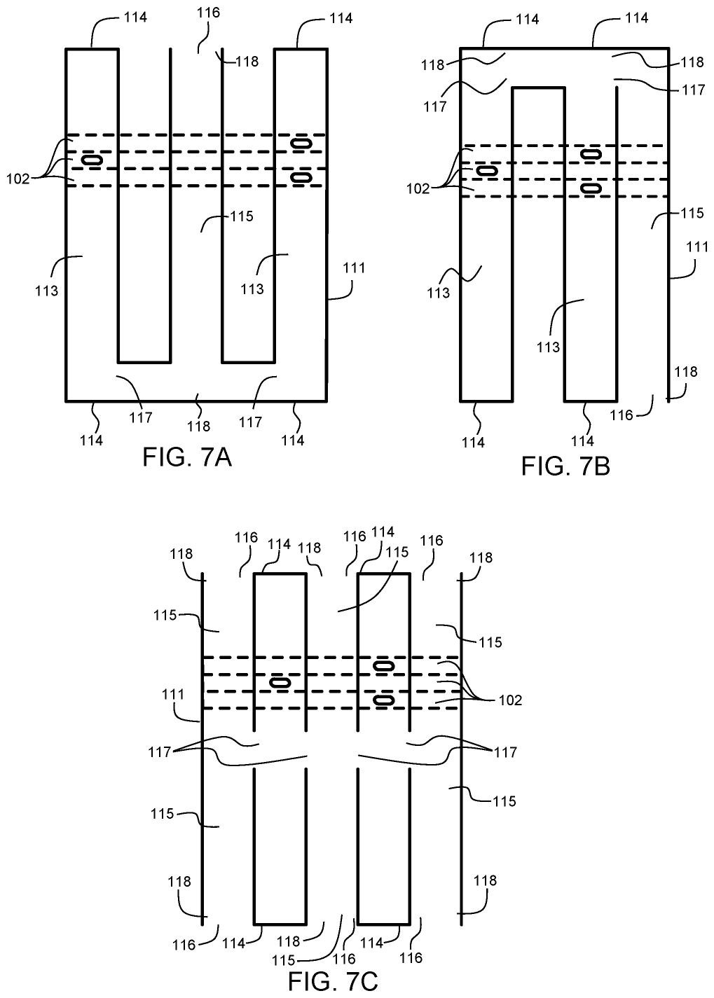

FIGS. 7A-7C depict embodiments of vent gas conduits 111 having dual vent gas manifolds 113 and either single or multiple vent gas runners 115 which, for purposes of the present description, means a path for battery cell vent gas from a port 117 to a respective outlet 116 at the end of the respective run of a vent gas runner 115.

FIG. 7A depicts dual, elongated vent gas manifolds 113 having respective ports 117 opening to a single, elongated vent gas runner 115. The ports 117 are located at one of the two ends 114 of the vent gas manifolds 113. The vent gas runner 115 in the embodiment of FIG. 7A may receive gas flow from opposite sides as battery cell vent gas exits the vent gas manifolds 113 at the respective ports 117. It is thus appreciated that the vent gas manifolds 113 are laid out on both sides of the vent gas runner 115. It is also appreciated that the vent gas runner 115 from the ports 117 to the outlet 116 at the end 118 of the vent gas runner 115 opposite the ports 117 is about as long as the length of the vent gas manifolds 113. FIG. 7B depicts dual, elongated vent gas manifolds 113 having respective ports 117 opening to a single, elongated vent gas runner 115. The ports 117 are located at one of the two ends 114 of the vent gas manifolds 113. The vent gas runner 115 in the embodiment of FIG. 7B may receive gas flow from one side as battery cell vent gas exits the vent gas manifolds 113 at the respective ports 117. It is thus appreciated that the vent gas manifolds 113 are laid out on one side of the vent gas runner 115. It is also appreciated that the vent gas runner 115 from the ports 117 to the outlet 116 at the end 118 of the vent gas runner 115 opposite the ports 117 is about as long as the length of the vent gas manifolds 113. FIG. 7C depicts dual, elongated vent gas manifolds 113 having respective ports 117, each with dual ports 117 located midway between their two ends 114 and opening on opposite sides of the vent gas manifold 113 to elongated vent gas runners 115. The embodiment of FIG. 7C depicts six vent gas runners-two between the vent gas manifolds 113 and two on each respective opposite side of each vent gas manifold 113. The vent gas runners 115 in the embodiment of FIG. 7C provide for a split gas flow (up and down in the depiction) as battery cell vent gas exits the vent gas manifold 113 at the respective port 117 thus providing for additional volumetric expansion of the gas without such a split flow. Each vent gas runner 115 opens at one of its two ends 118 to the respective port 117 and at the other one of its two ends 118 to a respective outlet 116 to the ambient environment external to the corresponding battery case (not shown). It is also appreciated that each vent gas runner 115, using each split path from the port 117 to the outlet 116 as a metric, is about half as long as the length of the vent gas manifold 113. It is also appreciated that the multiplicity of vent gas runners 115 and corresponding multiplicity of respective outlets 116 effectively distributes the battery cell vent gas and heat content so as to avoid concentration of the gas and heat to a more limited region as would be the case with fewer vent gas runners 115 and outlets 116.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

All numeric values herein are assumed to be modified by the term “about” whether or not explicitly indicated. For the purposes of the present disclosure, ranges may be expressed as from “about” one particular value to “about” another particular value. The term “about” generally refers to a range of numeric values that one of skill in the art would consider equivalent to the recited numeric value, having the same function or result, or reasonably within manufacturing tolerances of the recited numeric value generally. Similarly, numeric values set forth herein are by way of non-limiting example and may be nominal values, it being understood that actual values may vary from nominal values in accordance with environment, design and manufacturing tolerance, age and other factors.

When an element such as a layer, film, region, or substrate is referred to as being “on” another element, it can be directly on the other element or intervening elements may also be present. In contrast, when an element is referred to as being “directly on” another element, there are no intervening elements present. Similarly, when an element such as a layer, film, region, or substrate is referred to as being “adjacent” another element, it can be directly adjacent in contact or in spaced adjacency with the other element and intervening elements may or may not also be present. In contrast, when an element is referred to as being “directly adjacent” another element, it may be directly adjacent in contact or in spaced adjacency with the other element with no intervening elements present. Therefore, unless explicitly described as being “direct,” when a relationship between first and second elements is described in the above disclosure, that relationship may be a direct relationship where no other intervening elements are present between the first and second elements but may also be an indirect relationship where one or more intervening elements are present (either spatially or functionally) between the first and second elements.

One or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Unless defined otherwise, technical and scientific terms used herein have the same meaning as is commonly understood by one of skill in the art to which this disclosure belongs.

Unless specified to the contrary herein, all test standards are the most recent standard in effect as of the filing date of this application, or, if priority is claimed, the filing date of the earliest priority application in which the test standard appears.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An apparatus for evacuating battery vent gases, comprising:
a battery case containing a plurality of battery cells;
at least one vent gas manifold adjacent the plurality of battery cells configured to receive a gas from any battery cell that is venting the gas from a respective cell vent and to isolate the gas from any battery cell that is not venting the gas; and
at least one vent gas exhaust runner fluidly coupling the vent gas manifold to an ambient environment external to the battery case to provide a path for the gas isolated from the battery cells.

2. The apparatus of claim 1, further comprising a thermal barrier layer between the at least one vent gas manifold and the battery cells, the thermal barrier layer including a plurality of sacrificial regions corresponding in number to the plurality of battery cells, each sacrificial region aligned over a corresponding cell vent.

3. The apparatus of claim 2, further comprising a thermal barrier layer between the at least one vent gas exhaust runner and the battery cells.

4. The apparatus of claim 2, wherein the thermal barrier layer between the at least one vent gas manifold and the battery cells and the thermal barrier layer between the at least one vent gas exhaust runner and the battery cells are a unitary thermal barrier layer.

5. The apparatus of claim 3, wherein the thermal barrier layer between the at least one vent gas manifold and the battery cells comprises mica.

6. The apparatus of claim 1, wherein the at least one vent gas exhaust runner has an effective length that is at least substantially one-half of a length of the at least one vent gas manifold.

7. The apparatus of claim 1, wherein the at least one vent gas exhaust runner comprises a pair of vent gas exhaust runners and the at least one vent gas manifold is between the pair of vent gas exhaust runners.

8. The apparatus of claim 1, wherein the at least one vent gas exhaust runner substantially circumscribes the at least one vent gas manifold.

9. The apparatus of claim 1, wherein the at least one vent gas manifold comprises multiple vent gas manifolds, and wherein the at least one vent gas exhaust runner is not between any two of the multiple vent gas manifolds.

10. The apparatus of claim 1, wherein the at least one vent gas manifold comprises multiple vent gas manifolds, wherein the at least one vent gas exhaust runner comprises a single vent gas exhaust runner, and wherein the single vent gas exhaust runner is fluidly coupled to the multiple vent gas manifolds.

11. The apparatus of claim 1, wherein the at least one vent gas manifold comprises a pair of vent gas manifolds and the at least one vent gas exhaust runner is between the pair of vent gas manifolds.

12. The apparatus of claim 1, wherein the at least one vent gas exhaust runner comprises multiple vent gas exhaust runners having respective cross-sectional areas, wherein the at least one vent gas manifold comprises a single vent gas manifold having a respective cross-sectional area, and wherein the respective cross-sectional area of the single vent gas manifold is less than a sum of the respective cross-sectional areas of the multiple vent gas exhaust runners.

13. The apparatus of claim 1, wherein the at least one vent gas exhaust runner and the at least one vent gas manifold are substantially coplanar.

14. The apparatus of claim 1, wherein the at least one vent gas exhaust runner and the at least one vent gas manifold are stacked in adjacent layers.

15. The apparatus of claim 1, wherein the at least one vent gas exhaust runner is open to the ambient environment external to the battery case at multiple ends of the battery case.

16. An apparatus for evacuating battery vent gases, comprising:
a battery case containing a plurality of battery cells; and
a vent gas conduit adjacent the plurality of battery cells configured to receive a gas from any battery cell that is venting the gas from a respective cell vent, isolate the gas from any battery cell that is not venting the gas and fluidly couple the gas through a runner to an ambient environment external to the battery case.

17. The apparatus of claim 16, further comprising a thermal barrier layer between the vent gas conduit and the battery cells, the thermal barrier layer including a plurality of sacrificial regions corresponding in number to the plurality of battery cells, each sacrificial region aligned over a corresponding cell vent.

18. An apparatus for evacuating battery vent gases, comprising:
a battery case containing a plurality of battery cells, each battery cell having a respective cell vent for releasing a pressurized gas from the respective battery cell;
a thermal barrier layer having a first side adjacent to the battery cells and an opposite second side, the thermal barrier layer having a plurality of sacrificial regions corresponding in number to the plurality of battery cells, each sacrificial region aligned over a corresponding cell vent and responsive to the pressurized gas released from the corresponding cell vent to open and allow the pressurized gas to flow therethrough; and
a vent gas conduit adjacent the second side of the thermal barrier layer and configured to receive the pressurized gas from any battery cell that is venting the pressurized gas from the respective cell vent through the corresponding sacrificial region, and fluidly couple the pressurized gas to an ambient environment external to the battery case.

19. The apparatus of claim 18, wherein the vent gas conduit includes a vent gas manifold receiving the pressurized gas and at least one vent gas exhaust runner, the at least one vent gas exhaust runner fluidly coupling the vent gas manifold to the ambient environment external to the battery case.

20. The apparatus of claim 19, wherein the at least one vent gas exhaust runner includes at least one switchback directional change.
